(19) United States
(12) Patent Application Publication
(10) Pub. No.: US 2006/0235828 A1
(43) Pub. Date: Oct. 19, 2006

(54) User interface method for grouping conditions without editing

(75) Inventors: Richard D. Dettinger, Rochester, MN (US); Daniel P. Kolz, Rochester, MN (US); Shannon E. Wenzel, Colby, WI (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/012,905

(22) Filed: Dec. 15, 2004

(51) Int. Cl. G06F 17/30

(52) U.S. Cl. 707/3

(57) ABSTRACT

A method, computer-readable medium, and apparatus for programmatically providing a graphical user interface for creating queries are provided. Generally, the graphical user interface includes a first-level region for displaying one or more first-level query conditions and a first-level operator selection element, the selected first-level operator being applied to logically relate the one or more first-level query conditions. The graphical user interface also contains a second-level region for displaying two or more second-level query conditions and contains a second-level operator selection element, the selected second-level operator being applied to the two or more second-level query conditions within the second-level region to form a second-level query portion. The selected first-level operator is applied to the second-level query portion and the one or more query conditions of the first-level region to form a first-level query portion.

### CROSS-REFERENCE TO RELATED APPLICATIONS

This application is related to a commonly owned, co-pending U.S. patent application Ser. No. 10/083,073, filed Feb. 26, 2002, entitled “Graphical User Interface for Building Queries with Hierarchical Conditions” which is incorporated herein by reference in its entirety.

### BACKGROUND OF THE INVENTION

1. Field of the Invention

The present invention generally relates to a method, computer-readable medium, and apparatus for programmatically providing a graphical user interface for creating queries.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways.

Regardless of the particular architecture, in a DBMS, a requesting entity (e.g., an application or the operating system) demands access to a specified database by issuing a database access request. Such requests may include, for instance, simple catalog lookup requests or transactions and combinations of transactions that operate to read, change and add specified records in the database. These requests are made using high-level query languages such as the Structured Query Language (SQL). Illustratively, SQL is used to make interactive queries for getting information from and updating a database such as International Business Machines' (IBM) DB2, Microsoft's SQL Server, and database products from Oracle, Sybase, and Computer Associates. The term “query” denominates a set of commands for retrieving data from a stored database. Queries take the form of a command language that lets programmers and programs select, insert, update, find out the location of data, and so forth.

Often, each query takes the form of a hierarchy of query portions. A query portion, as used herein, is any part of a query, including conditions and conditions logically related together by Boolean logic operators. As defined herein, a condition is a comparison operation in which two operands are related by a comparison operator (e.g., >, <, =). An illustrative condition is (employeeName=‘Rich’). An example of conditions logically related grouped together by Boolean logic operators is ((employeeName=‘Rich’) OR (employeeName=‘John’)). The latter expression is also referred to as a complex condition, meaning that two or more conditions are logically related to form a resultant condition.

The individual constituent conditions of a complex condition may themselves be complex conditions. As an example, consider the logical expression ((employeeHire before 01/01/2000) AND ((employeeName=‘Rich’) OR (employeeName=‘John’))). The latter is a complex condition having a constituent complex condition, i.e., ((employeeName=‘Rich’) OR (employeeName=‘John’)). In this manner, a hierarchy of query portions may be created by using Boolean operators to relate conditions and/or other query portions. Each hierarchy of query portions and conditions may have several different levels (or nodes) where each level represents a number of query portions which are nested within parentheses. In the current example, the first level of the hierarchy of query portions contains two items: the condition (employeeHire before 01/01/2000) and the second level query portion ((employeeName=‘Rich’) OR (employeeName=‘John’)) which is nested within the first level and contains two conditions (i.e., a complex condition). Any level which is nested within another level may also be referred to as a sublevel. Thus, the second level may be considered to be a sublevel of the first level. Such hierarchical arrangements may also be described in the art with respect to root, branch and leaf terminology. [INVENTORS, IS THIS A TRUE STATEMENT?]

The representation of hierarchical query portions in a visual layout where users can intuitively manipulate the levels presents substantial difficulties. To understand the unique difficulties presented by hierarchical conditions, consider the following illustrations.

Data Hierarchy Illustration

<firstName>Rich</firstName>
<lastName>Dettinger</lastName>

</employee>

Query Portion Hierarchy Illustration
<AND>

<OR>

<employeeName = ‘Rich’>
<employeeName = ‘John’>

<employeeHire before 01/01/2000>

The first illustration (Data Hierarchy Illustration) is an XML data document fragment which has an obvious meaning. Specifically, an employee object is defined as having the attributes “firstName” and “lastName”. It is therefore feasible to show only <employee> without loss of meaning because users have a fundamental understanding of the whole object structure.

In contrast, the hierarchy of query portions illustrated above (Query Portion Hierarchy Illustration) is simply unrelated levels. When query portions of a hierarchy are being represented, a user interface cannot selectively show lower levels in the hierarchy because the user loses all context. This is because the hierarchy of query portions is arbitrary. For example, the above illustrated query portion hierarchy represents the following relational expression: ((employeeName=‘Rich’) OR (employeeName=‘John’)) AND (employeeHire before 01/01/200). However, there is no reason that a user may not want the following query instead: (employeeName=‘Rich’) OR ((employeeName=‘John’) AND (employeeHire before 01/01/200)). This latter expression is considerably different than the first, but equally valid.

Accordingly, the ability to represent hierarchical query portions, including conditions and conditions related by logical operators, in a visual layout where users can intuitively manipulate the levels of query portions is critical to being able to generate valid mathematical operations, relational database queries, etc.

Therefore, there is a need for a method and system for visually representing hierarchical query portions capable of being manipulated by users.

### SUMMARY OF THE INVENTION

The present invention generally—(will fill in with independent claims)

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with the invention;

FIG. 2 is a diagram depicting an exemplary graphical user interface for editing queries according to one embodiment of the invention;

FIG. 3 is a flow chart depicting a process for handling input to a graphical user interface according to one embodiment of the invention;

FIG. 4 is a graphical user interface screen for initiating the process of adding a condition to a query;

FIG. 5 is a graphical user interface screen for adding a birth date as a condition to a query;

FIG. 6 is a diagram depicting an exemplary graphical user interface for editing queries and containing a condition according to one embodiment of the invention;

FIG. 7 is a diagram depicting an exemplary graphical user interface for editing queries and containing several conditions according to one embodiment of the invention;

FIG. 8 is a diagram depicting an exemplary graphical user interface for editing queries and containing a selected first level operator according to one embodiment of the invention;

FIG. 9 is a diagram depicting an exemplary graphical user interface for editing queries and containing a sublevel according to one embodiment of the invention;

FIG. 10 is a diagram depicting an exemplary graphical user interface for editing queries and containing a sublevel having several conditions according to one embodiment of the invention;

FIG. 11 is a diagram depicting an exemplary graphical user interface for editing queries and containing a sublevel with a selected second level operator according to one embodiment of the invention;

FIG. 12 is a diagram depicting an exemplary graphical user interface for editing queries and containing several nested sublevels according to one embodiment of the invention;

FIG. 13 is a diagram depicting an exemplary graphical user interface for editing queries and containing several nested sublevels according to another embodiment of the invention;

FIG. 14 is a flow chart depicting a process for building a first level query portion according to one embodiment of the invention;

FIG. 15 is a flow chart depicting a process for building a sublevel query portion according to one embodiment of the invention;

FIG. 16 is a diagram depicting an exemplary graphical user interface for editing queries and containing minimized sublevels according to one embodiment of the invention;

FIG. 17 is a diagram depicting an exemplary graphical user interface for editing queries and containing a textual tree structure according to one embodiment of the invention; and

FIG. 18 is a diagram depicting an exemplary graphical user interface for editing queries and containing a graphical tree structure according to one embodiment of the invention.

### DETAILED DESCRIPTION OF THE PREFERRED EMBODIMENTS

The present invention generally is directed to a method, computer-readable medium, and apparatus for programmatically providing a graphical user interface for creating queries. In one embodiment, a graphical user interface includes a first-level region for displaying first-level query conditions and a first-level operator selection element, the selected first-level operator being applied to logically relate the first-level query conditions. At least one of the conditions included in the first-level region is represented as a second-level region for displaying two or more second-level query conditions and containing a second-level operator selection element, the selected second-level operator being applied to the two or more second-level query conditions within the second-level region to form a second-level query portion (i.e., a complex condition). The selected first-level operator is applied to the second-level query portion and the other first-level query conditions of the first-level region to form a first-level query portion.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

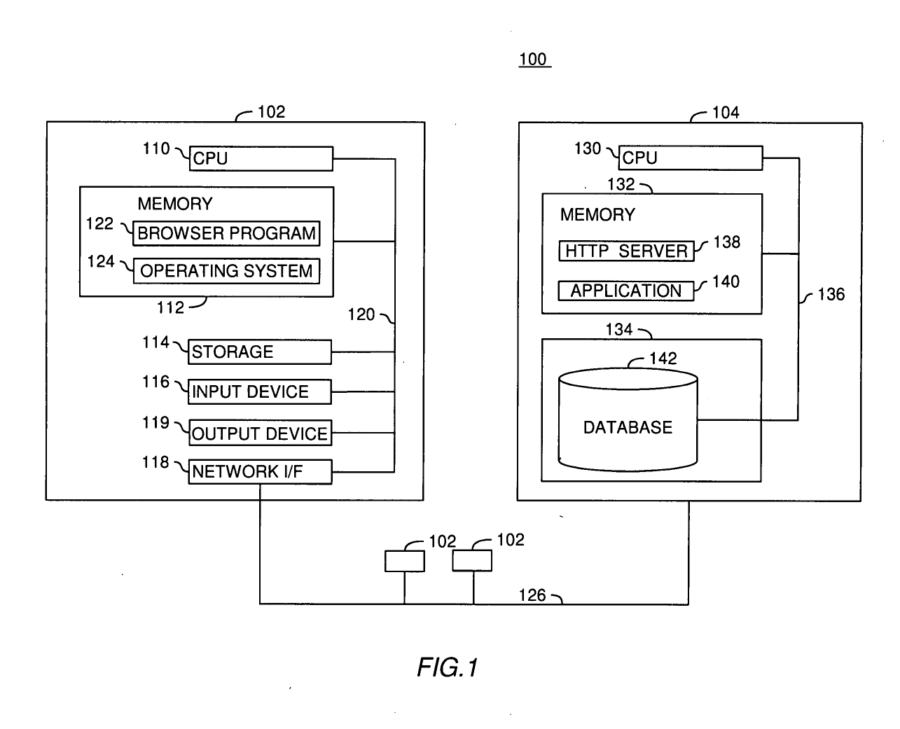

One embodiment of the invention is implemented as a program product for use with a computer system such as, for example, the computer system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

FIG. 1 depicts a block diagram of a networked system 100 in which embodiments of the present invention may be implemented. In general, the networked system 100 includes a client (e.g., user's) computer 102 (three such client computers 102 are shown) and at least one server 104 (five such servers 104 are shown). The client computer 102 and the server computer 104 are connected via a network 126. In general, the network 126 may be a local area network (LAN) and/or a wide area network (WAN). In a particular embodiment, the network 126 is the Internet.

The client computer 102 includes a Central Processing Unit (CPU) 110 connected via a bus 130 to a memory 112, storage 114, an input device 116, an output device 119, and a network interface device 118. The input device 116 can be any device to give input to the client computer 102. For example, a keyboard, keypad, light-pen, touch-screen, track-ball, or speech recognition unit, audio/video player, and the like could be used. The output device 119 can be any device to give output to the user, e.g., any conventional display screen. Although shown separately from the input device 116, the output device 119 and input device 116 could be combined. For example, a display screen with an integrated touch-screen, a display with an integrated keyboard, or a speech recognition unit combined with a text speech converter could be used.

The network interface device 118 may be any entry/exit device configured to allow network communications between the client computer 102 and the server computers 104 via the network 126. For example, the network interface device 118 may be a network adapter or other network interface card (NIC).

Storage 114 is preferably a Direct Access Storage Device (DASD). However, Storage 114 may be any form of persistent storage any and, although it is shown as a single unit, it could be a combination of fixed and/or removable storage devices, such as fixed disc drives, floppy disc drives, tape drives, removable memory cards, or optical storage. The memory 112 and storage 114 could be part of one virtual address space spanning multiple primary and secondary storage devices.

The memory 112 is preferably a random access memory sufficiently large to hold the necessary programming and data structures of the invention. However, any suitable form of memory is contemplated. Further, while the memory 112 is shown as a single entity, it should be understood that the memory 112 may in fact comprise a plurality of modules, and that the memory 112 may exist at multiple levels, from high speed registers and caches to lower speed but larger DRAM chips.

Illustratively, the memory 112 contains an operating system 124. Illustrative operating systems, which may be used to advantage, include Linux and Microsoft's Windows®, and International Business Machines' OS/400 or AIX. More generally, any operating system supporting the functions disclosed herein may be used.

The memory 112 is also shown containing a browser program 122 that, when executed on CPU 110, provides support for navigating between the various servers 104 and locating network addresses at one or more of the servers 104. In one embodiment, the browser program 122 includes a web-based Graphical User Interface (GUI), which allows the user to display Hyper Text Markup Language (HTML) information. More generally, however, the browser program 122 may be any GUI-based program capable of rendering the information transmitted from the server computer 104.

Each server computer 104 may by physically arranged in a manner similar to the client computer 102. Accordingly, each server computer 104 is shown generally comprising a CPU 130, a memory 132, and a storage device 134, coupled to one another by a bus 136. Memory 132 may be a random access memory sufficiently large to hold the necessary programming and data structures that are located on the server computer 104.

As shown, the memory 132 includes a Hypertext Transfer Protocol (http) server process 138 (e.g., a web server) adapted to service requests from the client computer 102. For example, the process 138 may respond to requests to access a data repository 142, which illustratively resides on the server 104. In particular, incoming client requests for data from the data repository 142 invoke an application 140. When executed by the processor 130, the application 140 causes the server computer 104 to perform the steps or elements embodying the various aspects of the invention, including accessing the data repository 142. In one embodiment, the application 140 comprises a plurality of servlets configured to build a graphical user interface (GUI), which is then rendered by the browser program 102. Embodiments of GUIs will be described below.

FIG. 1 is merely one hardware/software configuration for the networked client computer 102 and server computer 104. Embodiments of the present invention can apply to any comparable hardware configuration, regardless of whether the computer systems are complicated, multi-user computing apparatus, single-user workstations, or network appliances that do not have non-volatile storage of their own. Further, it is understood that while reference is made to particular markup languages, including HTML, the invention is not limited to a particular language, standard or version. Accordingly, persons skilled in the art will recognize that the invention is adaptable to other markup languages as well as non-markup languages and that the invention is also adaptable future changes in a particular markup language as well as to other languages presently unknown. Likewise, the http server process 138 shown in FIG. 1 is merely illustrative and other embodiments adapted to support any known and unknown protocols are contemplated.

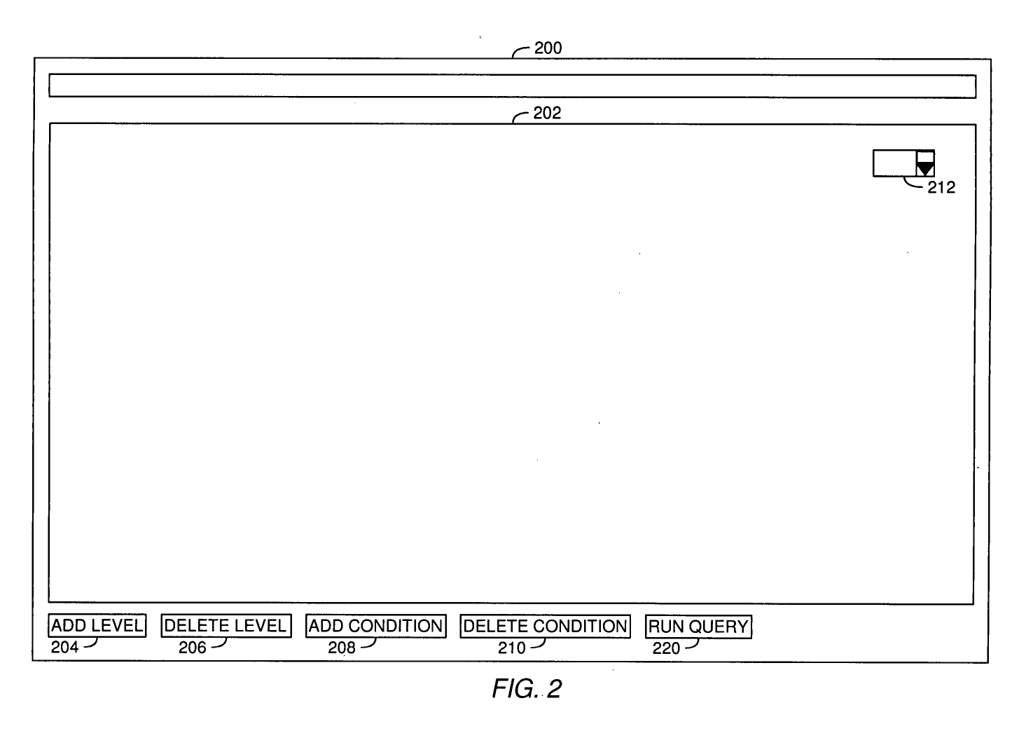

FIG. 2 depicts an exemplary graphical user interface (GUI) 200 for composing and editing (generally referred to herein as “editing”) queries according to one embodiment of the invention. In one embodiment, each query may be edited within a region 202 within the GUI 200. The region 202 may represent the first level of a hierarchical query. The region 202 which represents the first level may also be referred to as a palette, as the top level, or as the root level. The GUI 200 may also provide graphical elements 204, 206, 208, and 210 for modifying conditions and levels, as well as a graphical element 220 for executing queries. The graphical elements may be buttons or other input elements known to those skilled in the art, such as drop-down menus. In the illustrative embodiment, the graphical element 204 is configured for adding levels, the graphical element 206 is for deleting levels, the graphical element 208 is for adding conditions, and the graphical element 210 is for deleting conditions. The GUI 200 may also contain a graphical element 212 for selecting a first level logic operator.

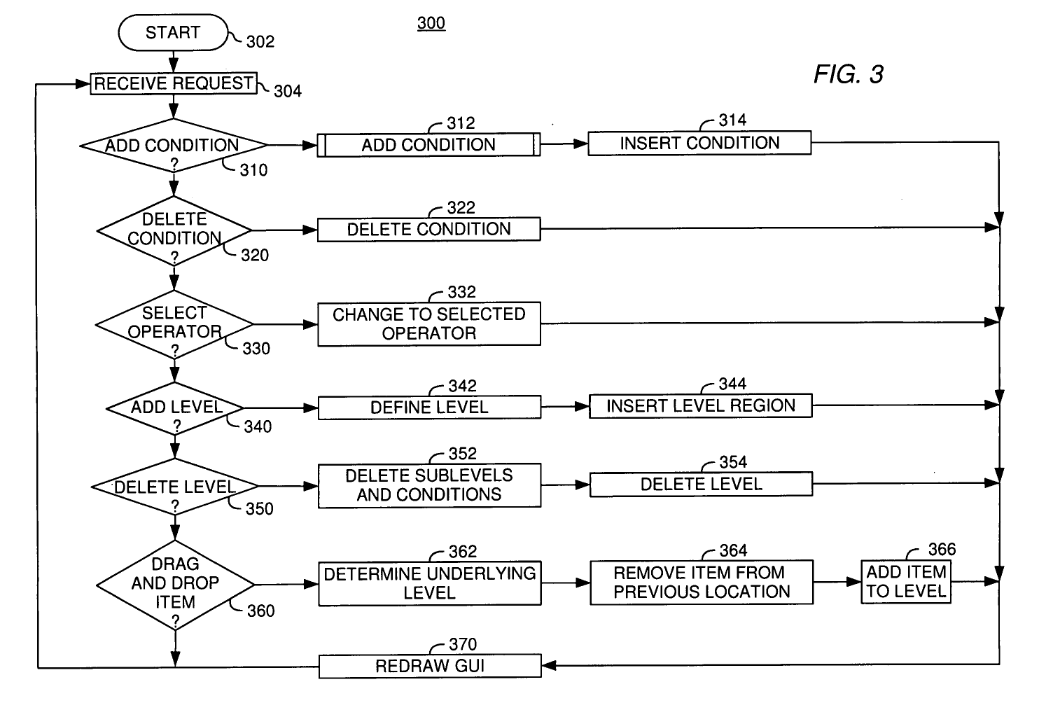

According to one embodiment, input to the GUI 200 may be handled by a process such as the process 300 depicted in FIG. 3. In one embodiment, the process 300 is event driven and implemented by one or more event handlers. The process 300 may begin at step 302 and continue to step 304 where a request is received. The request may be made by the user activating one of the graphical elements 204, 206, 208, 210, 212 in the GUI 200, using input from a mouse or keyboard, or in any other form known to those skilled in the art. In each of the following cases, after the request has been completely processed, or if no type of recognized request is received, the process 300 may continue while waiting for input at step 304.

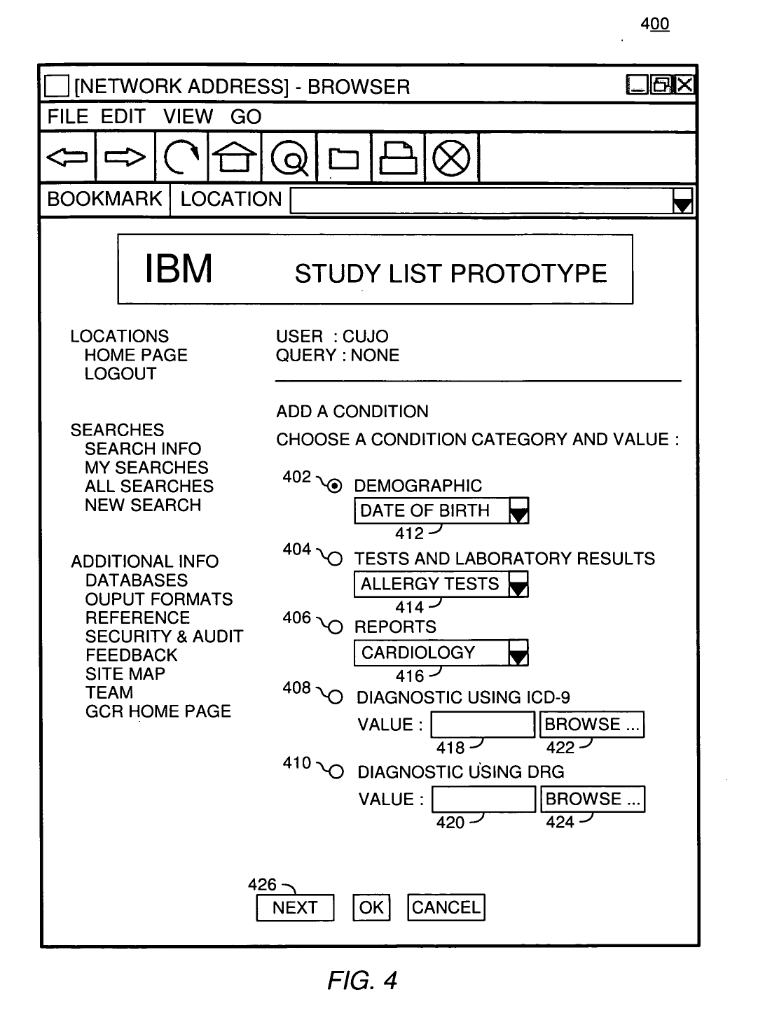

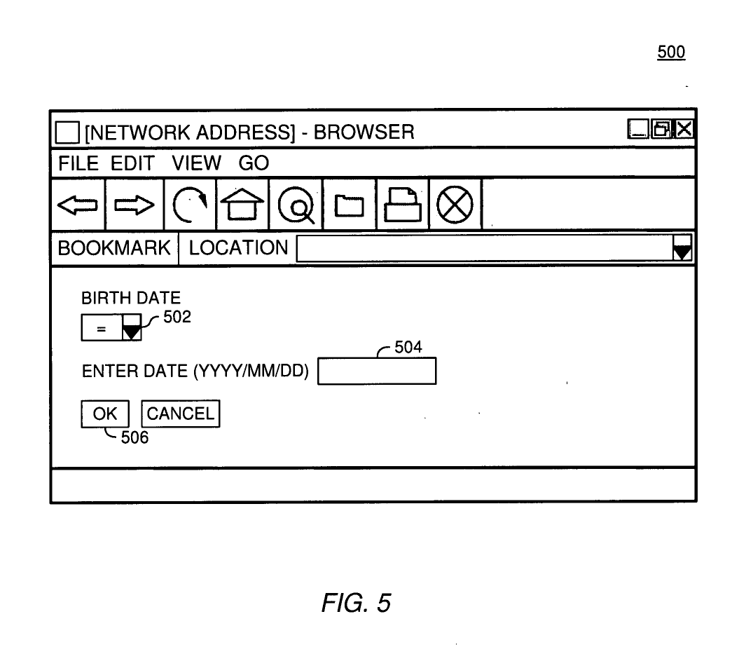

At step 310, a determination may be made of whether the request is a request to add a condition. Such a request may, for instance, be received upon a user activating the graphical element 208 for adding conditions. If the request is to add a condition, the process may continue to step 312 where a process for adding a condition is initiated. According to one embodiment, upon requesting that a condition be added, the user may be presented with several GUIs as depicted in FIGS. 4-5 which assist the user in adding conditions. By way of illustration, the graphical user interfaces shown in FIGS. 4-5 are specific to adding conditions for accessing medical data. However, embodiments of the invention may be used to advantage with any type of information including, for example, financial information, employment information, etc.

The GUI 400 is the first of a series of screens which a user uses to add a condition to a query. Recall that, as defined herein, a condition is a comparison operation. An illustrative condition is (DateOfBirth=‘1942/01/01’). Thus, adding a condition to a query generally involves allowing the user to select operands and a comparison operator (e.g., >, <, =). In general, the GUI 400 includes a plurality of condition categories 402-410 from which a user may select. The condition categories shown include “demographics” 402, “tests and laboratory results” 404, “reports” 406, “diagnostic using ICD-9” 408, and “diagnostic using DRG” 410. Each of the condition categories has an associated field 412-420 from/into which a value may be selected/input. Some fields (e.g., fields 412-416) are drop-down menus, while others are text boxes (e.g., fields 418-420) for receiving user input. In the latter case, the fields may have associated Browse buttons 422-424 to facilitate user selection of valid values.

Once a condition category and value have been selected, the user clicks on the Next button 426. Clicking the Next button 426 may cause the next appropriate GUI necessary to continue the process of adding a condition to be displayed. In this manner, the user may be presented with a series of graphical user interfaces necessary to add a condition. By way of example, assume that the user has selected the demographic condition category 402 and the “date of birth” value from the drop-down menu 412. Upon pressing the Next button 426, the user is presented with a second GUI 500 shown in FIG. 5. The GUI 500 comprises a comparison operator drop-down menu 502 from which a user may select a comparison operator (e.g., >, <, =) and a date field 504 into which a user may input a date according to a prescribed format (e.g., “yyyy/mm/dd”). The process of adding the date of birth condition is completed when the user clicks on the OK button 506.

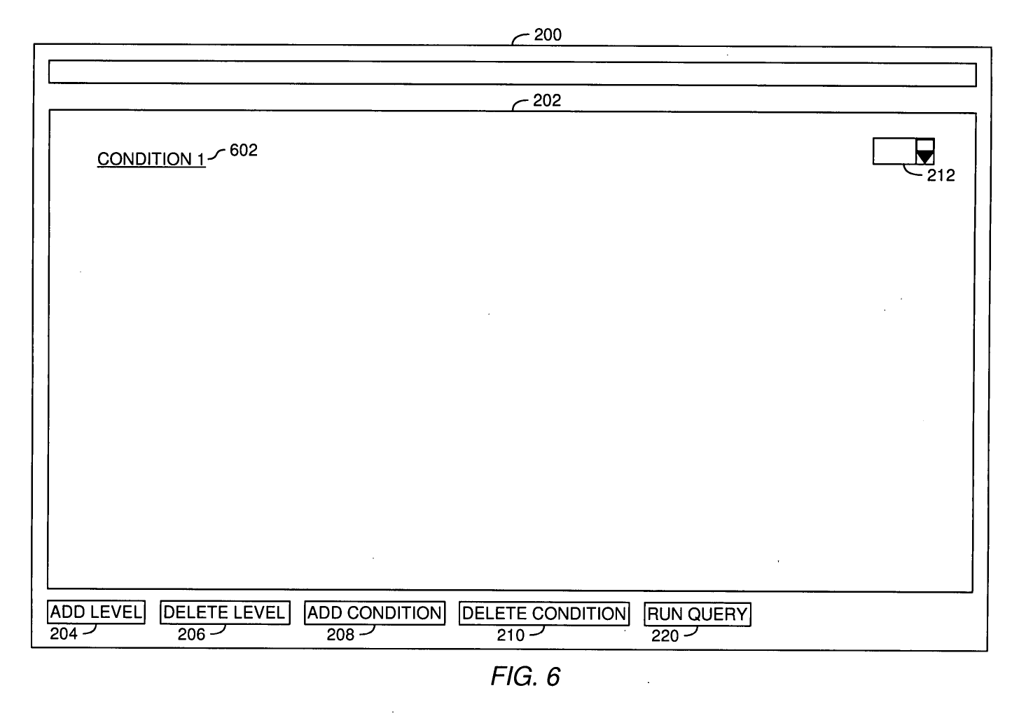

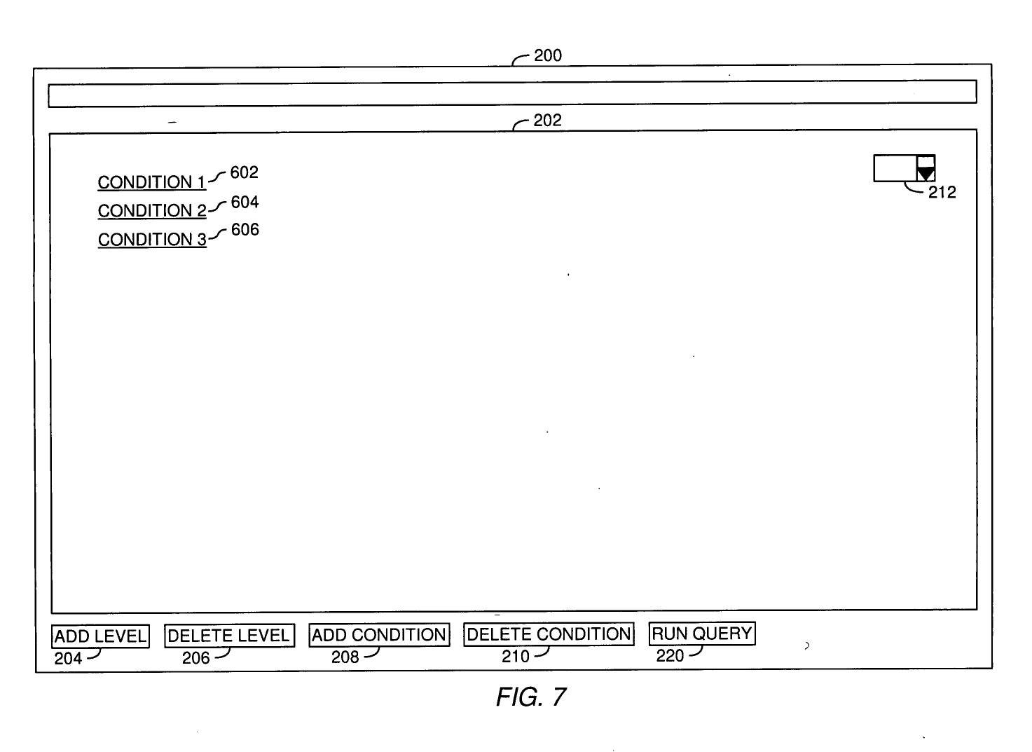

When the user has completed the process of adding a condition (e.g., such as after clicking the OK button 506), the process 300 for handling input to the GUI 200 may continue to step 314 where the condition is inserted into the region 202 which represents the first level of the hierarchy of query portions. Thus, after clicking the OK button 506 to finish adding the condition, the GUI 200 may appear to the user as depicted in FIG. 6. The user may repeat this process to add multiple conditions the first level (or any sublevel as will be described below). Thus, the GUI 200 may appear as in FIG. 7 with several conditions 602, 604, 606 appearing within the top level region 202.

In the illustrative embodiment of FIGS. 6 and 7 the added conditions are generically represented as CONDITION N, where N is an integer (e.g., CONDITION 1, CONDITION 2, etc.). This approach provides a convenient mode of displaying query conditions in a manner that avoids clutter caused by voluminous text. Where conditions are displayed in such a generic, abbreviated form it is contemplated that each condition may be given a unique name. In the present example conditions are given the name CONDITION and a number, i.e., CONDITION 1, CONDITION 2, etc. In this case the condition names may be automatically assigned based on the order in which the condition was added. In other embodiments, the user may be allowed to assign or change the condition name. In one embodiment, the user may view the underlying text of a given condition as fly-over text by positioning a mouse cursor over the respective condition name. Of course, displaying the added condition in a fully resolved fashion, i.e., the actual text of the condition, is also contemplated.

In addition to creating conditions and adding the created condition to the region 202 (or a sublevel, as will be described below) in the manner described above, conditions may be also be moved from a location in the GUI into the region 202. For example, the GUI may include a condition list displaying predefined conditions (e.g., conditions that were previously created and then stored). A user may then drag-and-drop the conditions from the condition list into the region 202.

The user may also be allowed to delete conditions. Such a request may be made by the user by selecting the condition to be deleted and activating the graphical element 210 for deleting conditions. This may cause the process 300 to receive a request at step 304 and, at step 320, it may be determined that the request is a request to delete a condition. The process may continue to step 322 where the condition is deleted and then to step 324 where the GUI 200 is redrawn to reflect the changes (not depicted). After processing the request to delete a condition, the process 300 may continue processing input events at step 304.

As noted above with respect to FIG. 7, the graphical element 208 for adding conditions may be used to add several conditions to the region 202 representing the first level. After adding several conditions, the user may wish to select a first level logic operator which may be applied to logically relate each of the individual conditions 602, 604, 606 in the first level region 202. In one embodiment, the user may select an operator by activating the graphical element 212.

In one embodiment, the graphical element 212 may be a pull-down menu which allows the user to select from a variety of operators. In other embodiments, the graphical element 212 may be a text box in which the user may type a logic operator, or the graphical element 212 may be a button which activates a dialog box which prompts the user for input. More generally, the graphical element 212 may be any other type of element known to those skilled in the art. Until the first level logic operator has been selected using the graphical element 212, the graphical element 212 may appear blank as depicted in FIG. 7 and (at least in one embodiment) any attempts to create a query where a logic operator has not been selected may result in an error notification being displayed to the user. Optionally, a default value for each logic operator may be provided automatically to the user.

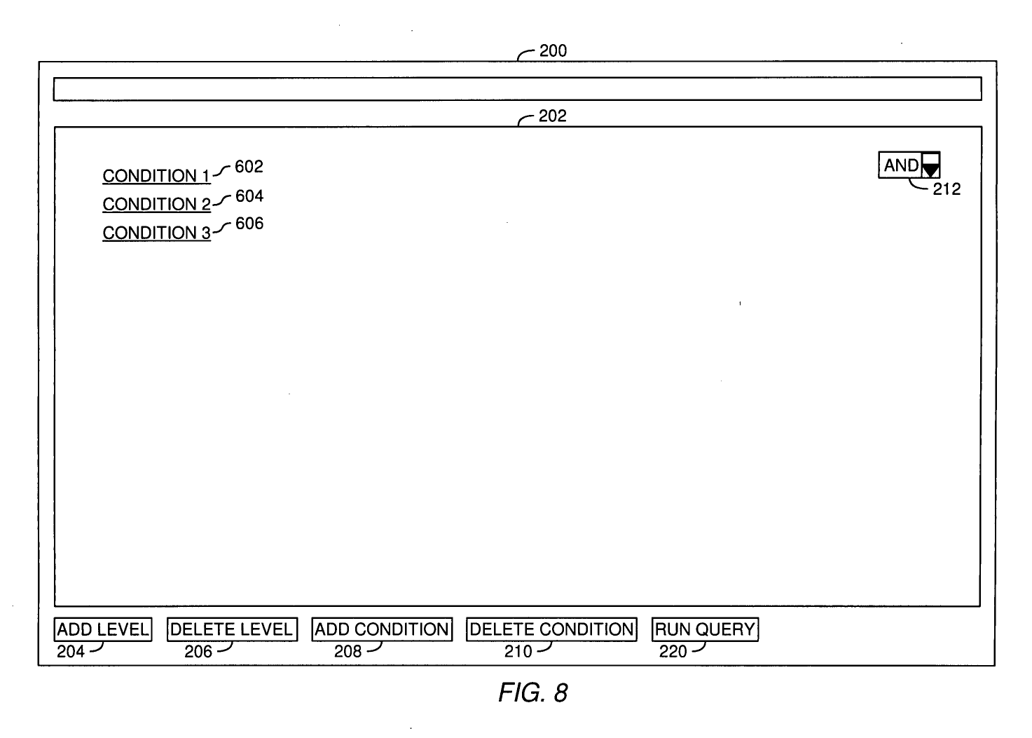

Upon activating the graphical element 212, a request may be sent to process 300. Thus, at step 330, a determination may be made that the request is a request to select a logic operator. Upon determining that a request to change the logic operator has been made, the process may then continue to step 332 where the selected logic operator may be displayed in the first level region 202 as depicted in FIG. 8. If the user later decides to change the logic operator, the user may do so by activating the graphical element 212 again. After processing the request, the process 300 may continue processing input events at step 304.

In some cases a user may decide to create a complex query. To this end, the user may create a sublevel region within the displayed user interface. A sublevel region is a defined region of the interface in which the user may add and logically relate one or more conditions; although in the case of a complex condition at least two conditions would be related in the sublevel. As such, a sublevel region may be visually and functionally the same or similar to the first level region. In one embodiment, a sublevel region is created by activating the graphical element 204. Upon activating the graphical element 204, a request may be sent to process 300. Thus, at step 340, a determination may be made that a request to add a sublevel region has been made and at step 342 a new region may be automatically defined. Defining a new region may include determining where to place the new region which will represent the sublevel and how large to make the new region. The process of defining a new region may also include creating a data structure representing the new sublevel and interfacing the new data structure with any data structures representing the first level. A name may also be automatically assigned to the new sublevel region based on the order in which the region was added. For instance, if the region being added is the first added sublevel region, it may be automatically named ‘SUBLEVEL 1’. In one embodiment, the user may be allowed to assign a descriptive name to the sublevel or to rename the level once the sublevel has been added.

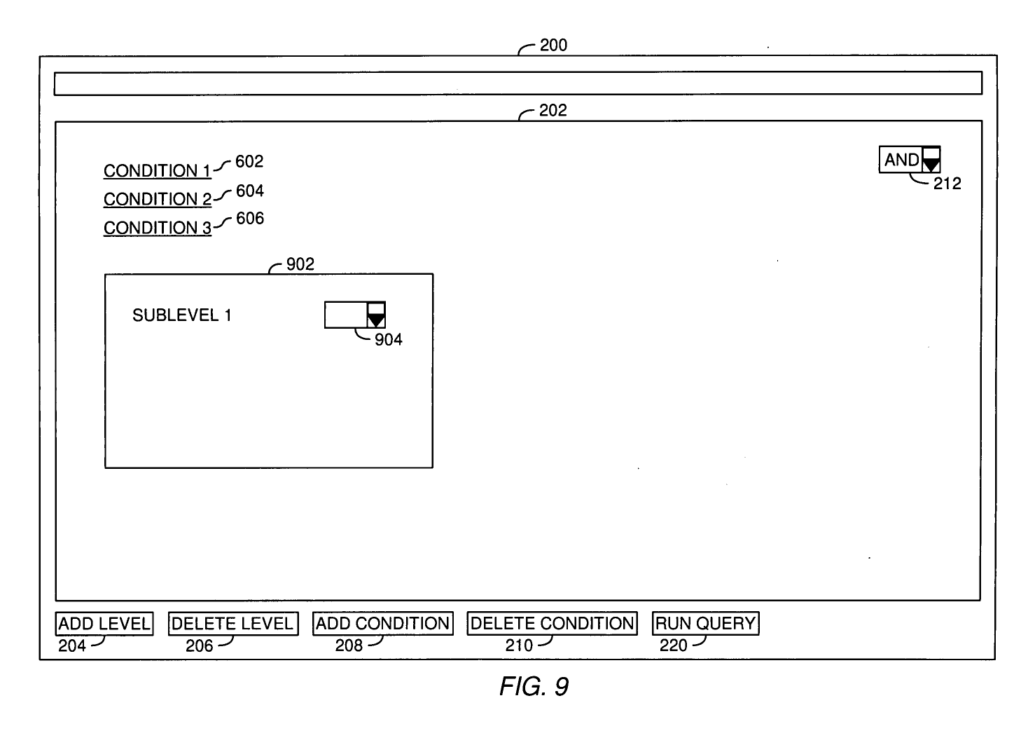

After defining the new region at step 342, the process 300 may continue to step 344 where the new region is inserted into the GUI 200. According to one embodiment (depicted in FIG. 9), the new region 902 representing the new sublevel may be inserted into the region 202 representing the first level. Because the region 902 representing the sublevel is nested within the region representing the first level, the new region may be said to represent a second level, or the first sublevel. The region 902 may also contain a graphical element 904 for selecting a second level logical operator. As described above, until the user selects a second level logical operator, the graphical element 904 may remain blank. In other embodiments, the user may be prompted as to where the sublevel should be inserted or the user may be allowed to draw the region representing the new sublevel using a mouse or other input device instead of having the region and sublevel automatically defined. After processing the request, the process 300 may continue processing input events at step 304. The user may repeat this process iteratively N number of times to create N number of nested sublevels, where each sublevel is a node of a query.

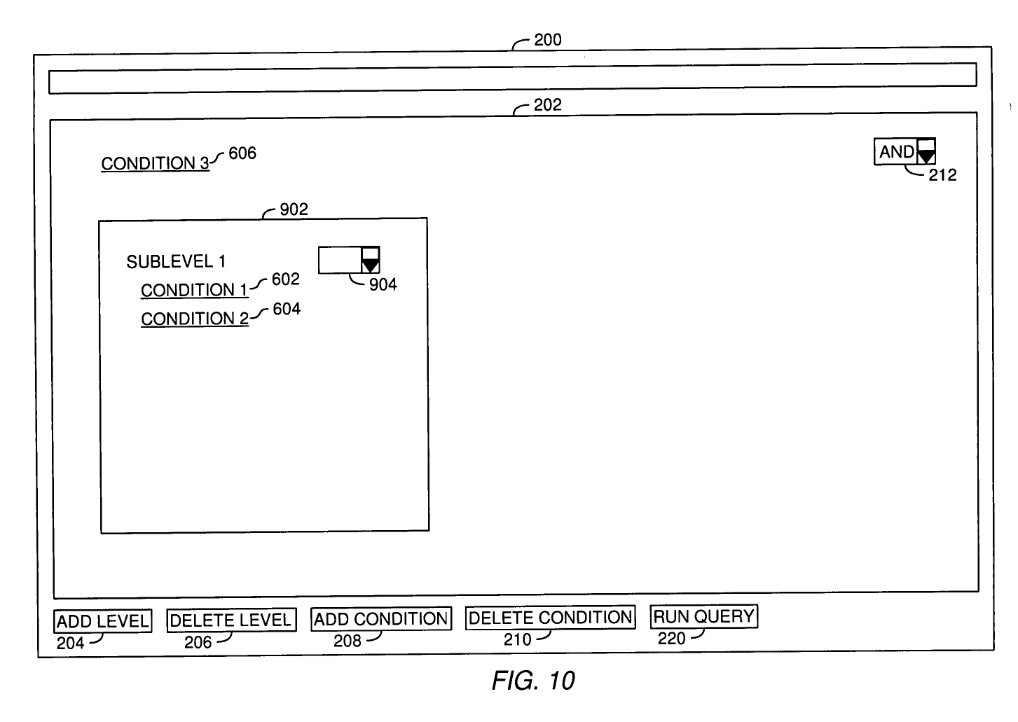

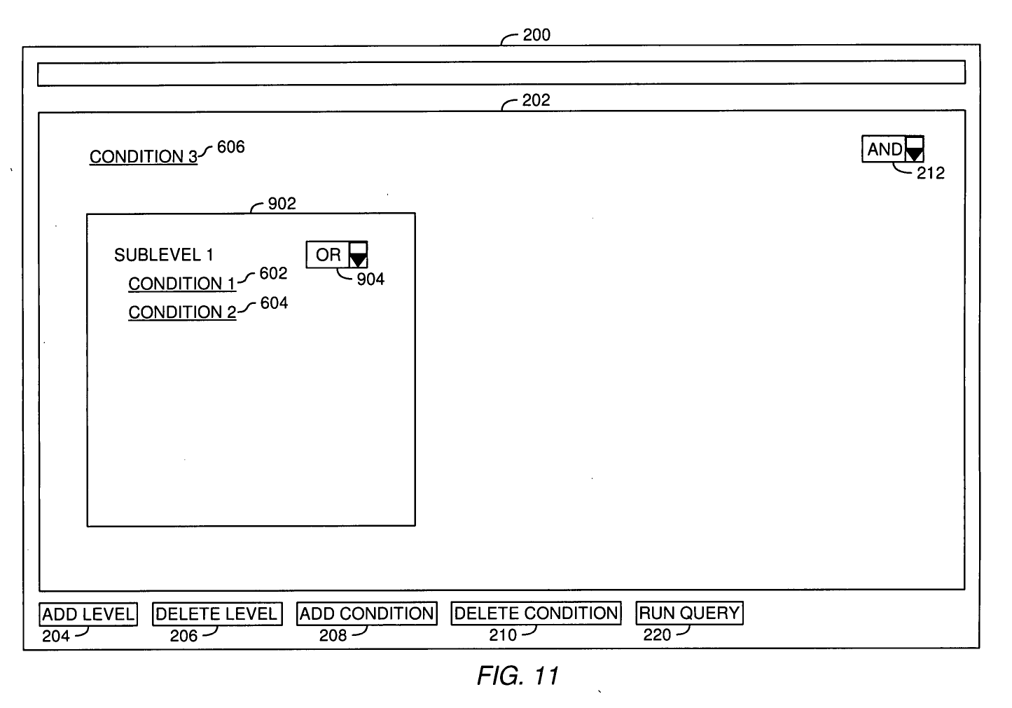

After inserting a level, the user may also wish to add conditions or other levels as sublevels to the inserted level. In one embodiment, the user may insert conditions or sublevels (referred to generally as “items”) into a level by dragging and dropping the items into the desired level. Dragging and dropping an item may cause a request to be sent to the process 300 which handles input to the GUI 200. Thus, at step 304 the request may be received and at step 360 it may be determined that the request is a request to drag and drop an item. At step 362, the underlying level where the item is dropped may be determined and at step 364 the item may be inserted into the determined underlying level. After processing the request, the process 300 may continue processing input events at step 304. As an example, the user may decide to drag the first created condition 602 and the second created condition 604 from the first level region 202 into the second level region 902 as depicted in FIG. 10. The user may then use the graphical element 904 to select a second level operator to be applied individually to the conditions 602, 604 in the second level region 802, as depicted in FIG. 11.

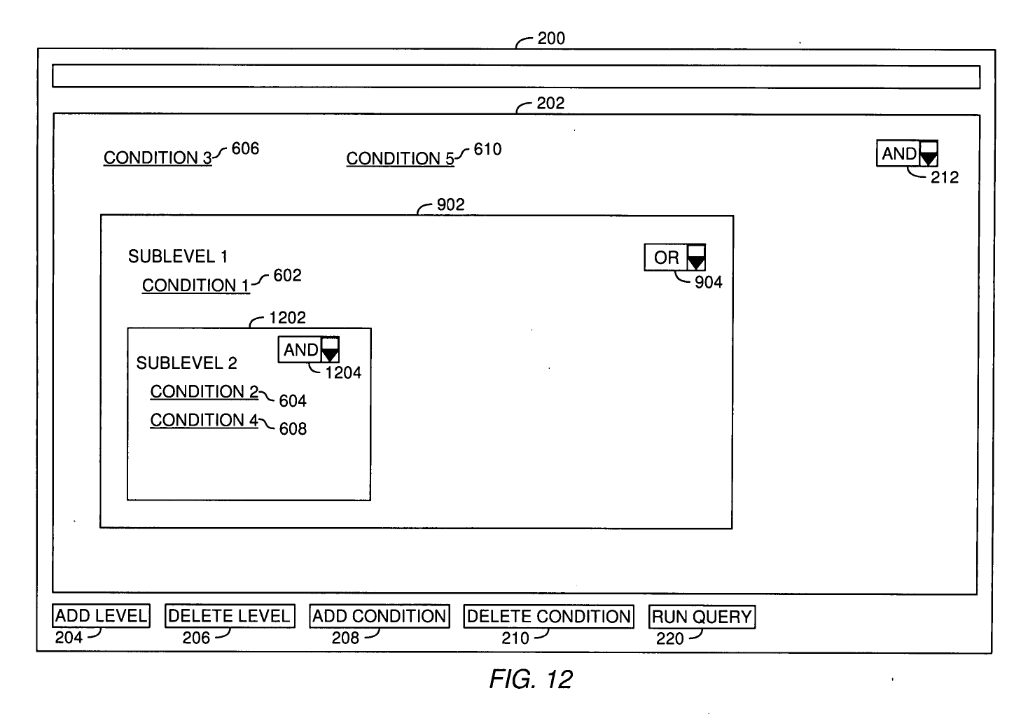

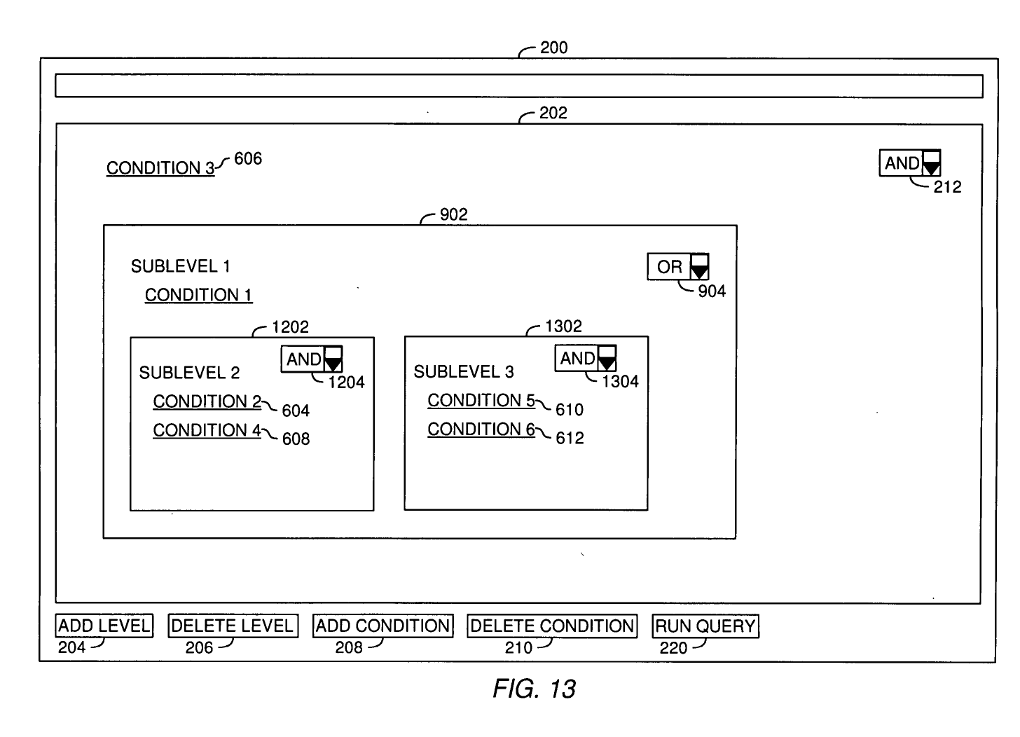

By inserting levels and conditions and then dragging and dropping the levels and conditions, the user may be allowed to create many different configurations of levels and conditions. For instance, the user may add a third level region 1202 (named ‘SUBLEVEL 2’ because it was the second added sublevel) to the second level region 902. The user may also insert a fifth condition 610 into the first level region 202, drag and drop the second condition 604 into the third level region 1202, insert a fourth condition 608 into the third level region 1202, and select a logic operator to apply to the individual conditions in the third level region 1202 using the graphical element 1204. The result of these actions is depicted in FIG. 12. For another example, as depicted in FIG. 13, the user may have added another third level region 1302 (named ‘SUBLEVEL 3’ because it was the third inserted sublevel). The user may also have moved the fifth condition 610 and inserted a sixth condition 612 into the third level region 1302 and selected a logical operator to apply to the fifth condition 610 and sixth condition 612 using graphical element 1304.

It should be noted that each sublevel is effectively a condition (complex or simple) from the perspective of the immediately higher level. For example, with respect to FIG. 13, the second level region 1202 and the third level region 1302 both represent conditions of the first level region 202.

After inserting a level, the user may later wish to delete the level. Such a request may be made by the user by selecting the region representing the level to be deleted and activating the graphical element 206 for deleting conditions. This may cause the process 300 to receive a request at step 304 and at step 350, it may be determined that the request is a request to delete a level. The process may continue to step 352 where any conditions or sublevels within the level are deleted and at step 354 the actual level is deleted. At step 356 the GUI 200 is redrawn to reflect the changes (not depicted). After processing the request, the process 300 may continue processing input events at step 304.

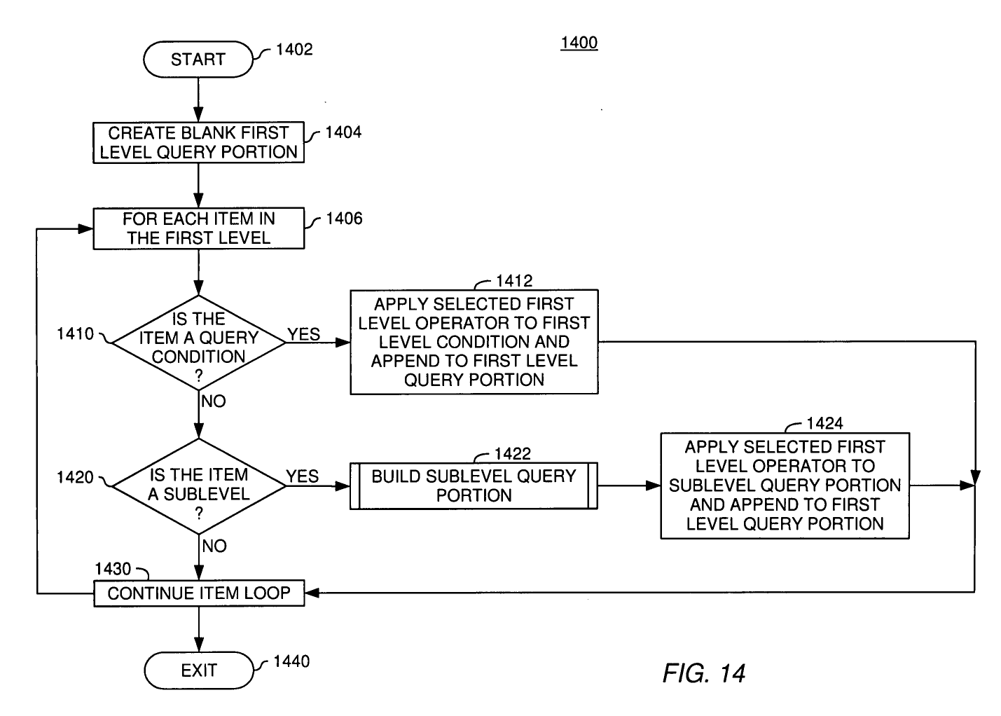

After creating a hierarchical view of the levels, operators, and conditions in a query, the user may wish to execute the query which is represented by the hierarchical view. Accordingly, the user may activate the graphical element 220 for executing the query. Upon activating the graphical element 220, a process 1400 for building the query, depicted in FIG. 14, may be initiated. FIG. 14 depicts a process 1400 for building a query according to one embodiment of the invention. The process 1400 may begin at step 1402 and continue to step 1404 where a blank query portion for the first level is created. The blank query portion is used to form the final query from the query portions created by the process 1400. The blank query portion will also be used to execute the final query.

After the blank query portion has been created at step 1404, the process may continue to step 1406 where a loop is entered. The loop may iterate through each item in the first level. Thus, if the process 1400 were initiated on the GUI 200 as depicted in FIG. 3, the first item that the loop would iterate over would be the first condition 602. If the loop were initiated on the GUI 200 as depicted in FIG. 11, the loop would iterate over the items in the first level region 202, namely the third condition 606 and the second level.

At step 1410, a determination would be made of whether the item within the first level is a query condition. If the item is a query condition, the selected first level operator may be applied to the query condition and appended to the first level query portion at step 1412. Thus, if the process 1400 were initiated on the GUI 200 as depicted in FIG. 8, on the first iteration of the loop beginning at step 1406, the query portion would be amended with parentheses as “(CONDITION 1)” because “(CONDITION 1)” is the result of applying the “AND” operator to “(CONDITION 1)” (a condition ANDed with nothing else is just the condition). After step 1412, the loop may be continued at step 1430. Continuing with the example with respect to FIG. 8, the next iteration of the loop would find that the next item is a condition (the second condition 604) at step 1410, and the selected first level operator would be applied to the second query condition and appended to the first level query portion at step 1412. Thus, with respect to FIG. 8, at step 1412, the first level query portion would be changed to “(CONDITION 1 AND CONDITION 2)” after applying the first level operator (“AND”) to the second condition 604 and appending the result (“AND CONDITION 2”). After another iteration, the query portion would be changed to “(CONDITION 1 AND CONDITION 2 AND CONDITION 3)” and, after finishing the loop, the process 1400 would terminate at step 1440.

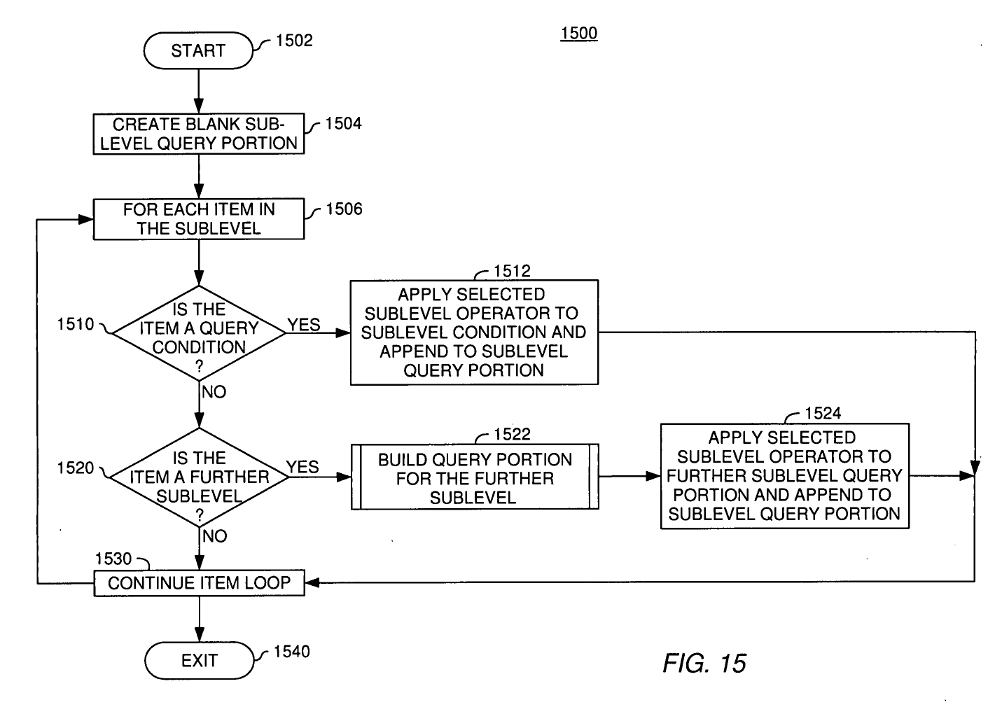

If the process 1400 were initiated on the GUI 200 as depicted in FIG. 11, after the first iteration had changed the first level query portion to “(CONDITION 3)”, the loop would continue at step 1406 where the next item encountered by the loop would be the sublevel “SUBLEVEL 1”. Thus, at step 1420, a determination would be made that the item was a sublevel and at step 1422 a sublevel query portion would be built. According to one embodiment of the invention, the sublevel query portion is built by calling the process 1500, depicted in FIG. 15.

FIG. 15 depicts a process 1500 for building sublevel query portions according to one embodiment of the invention. The process 1500 may begin at step 1502 and continue to step 1504 where a blank query portion for the sublevel is created. The blank query portion is then populated according to the rest of the process 1500 and, once populated, the resulting query portion will be appended to the first level query portion created by the process 1400 to contribute to the final query.

At step 1506, a loop may be entered which will iterate across each item in the sublevel. Thus, in the case discussed with respect to FIG. 11, the loop would iterate across each item in the second level region 902 (the first condition 602 and the second condition 604). In the case discussed with respect to FIG. 12, the loop would iterate across the first condition 602, the fifth condition 610, and the third level (represented by the third level region 1202). With respect to FIG. 13, the loop would iterate across the first condition 602 and the two third level regions 1202, 1302.

At step 1510, a determination may be made of whether the item being examined in the sublevel is a condition. If the item is a condition, the selected sublevel operator would be applied to the sublevel condition and the result would be appended to the sublevel query portion at step 1512. Thus, with respect to FIG. 11, on the first iteration, the first condition 602 would be added to the sublevel query portion as “(CONDITION 1)” because “(CONDITION 1)” is the result of applying the “OR” operator to “(CONDITION 1)” (a condition ORed with nothing else is just the condition). After appending the new query portion, the loop would continue at step 1530 to the next item. Thus, with respect to FIG. 11, the next item the loop would cover would be the second condition 604. The second level operator “OR” would be applied to the second condition 604 and appended to the sublevel query portion at step 1512, resulting in a sublevel query portion of “(CONDITION 1 OR CONDITION 2)”.

With respect to FIG. 11, the loop would not continue at step 1530 because each of the items in the sublevel region 902 would have been examined, and the process 1500 would terminate at step 1540, causing the process 1400 to resume at step 1424. If, however, the processes were initiated with respect to the GUI 200 depicted in FIG. 12, the loop beginning at step 1506 would first examine the first condition 602 in the sublevel region 902 and the loop would then continue to the next item, the third sublevel represented by region 1202. A determination would be made at step 1520 as to whether the item being examined was a further sublevel. Because the next item in FIG. 12 is a sublevel (“SUBLEVEL 2”), at step 1522 another query portion would be built for the further sublevel. The query portion for the further sublevel would be built by performing the process 1500 recursively, i.e., by performing the same process on the third level. Thus, in a manner known to those skilled, the query may be built from any number of levels nested within other levels. Thus, with respect to FIG. 12, a query portion for the third level would be built using process 1500 and would result in the query portion “(CONDITION 2 AND CONDITION 4)”.

After building a query portion for the further sublevel at step 1522, the process 1500 continues to step 1524 where the sublevel operator is applied to the further sublevel query portion and the result is appended to the sublevel query portion. Thus, with respect to FIG. 12, by applying the process 1500 as described above, the query portion before step 1524 would be “(CONDITION 1)”. After step 1524, the selected operator (“AND”) for the sublevel would be applied to the query portion for the further sublevel “(CONDITION 2 AND CONDITION 4)” and appended to the sublevel query portion, resulting in “(CONDITION 1 and (CONDITION 2 AND CONDITION 4))”. The loop beginning at step 1506 would then finish and the process 1500 would finish at step 1540, allowing the process 1400 to continue at step 1424. With respect to FIG. 13, the resulting sublevel query portion, after applying the process 1500 to the condition 602 and further sublevels 1202, 1302 would be (CONDITION 1 OR (CONDITION 2 AND CONDITION 4) OR (CONDITION 5 AND CONDITION 6)).

After building the sublevel query portions as step 1422 and using process 1500, the process 1400 would resume at step 1424 where the selected first level operator is applied to the query portion for the sublevel and the result is appended to the query portion for the first level. Thus, with respect to FIG. 11, where the query portion is “(CONDITION 3)”, the selected first level operator is “AND”, and the sublevel query portion is “(CONDITION 1 OR CONDITION 2)”, the result of step 1424 is “(CONDITION 3 AND (CONDITION 1 OR CONDITION 2))”. It should be understood that for a given level, the constituent conditions of the given level will independently be applied to the entire sublevel node according to the logical operator of the given level. In the example of FIG. 11, CONDITION 3 is logically ANDed to the entire sublevel node (CONDITION 1 OR CONDITION 2). If the first level had contained additional conditions, each one of those would have been separately ANDed to the entire sublevel node (CONDITION 1 OR CONDITION 2). Such a result is seen, for example, with respect to FIG. 12 where each of the first level conditions (the third condition 606 and the fifth condition 610) are ANDed with the sublevel node “(CONDITION 1 OR (CONDITION 2 AND CONDITION 4)” resulting in a first level query portion of (CONDITION 3 AND CONDITION 5 AND (CONDITION 1 OR (CONDITION 2 AND CONDITION 4)). After each of the sublevel query portions and conditions in first level have been examined in the loop, the process 1400 may finish at step 1440. The resulting queries with respect to the figures discussed above are depicted in Table I.

TABLE I
RESULTING QUERIES FOR SELECTED FIGURES

| FIGURE | RESULTING QUERY |
|---|---|
| | (CONDITION 1 AND CONDITION 2 AND |
| | CONDITION 3) |
| | (CONDITION 3 AND (CONDITION 1 |
| | OR CONDITION 2)) |
| | (CONDITION 3 AND CONDITION 5 AND |
| | (CONDITION 1 OR |
| | (CONDITION 2 AND CONDITION 4)) |
| | (CONDITION 3 AND (CONDITION 1 OR |
| | (CONDITION 2 AND CONDITION 4) OR |
| | (CONDITION 5 AND CONDITION 6)) |

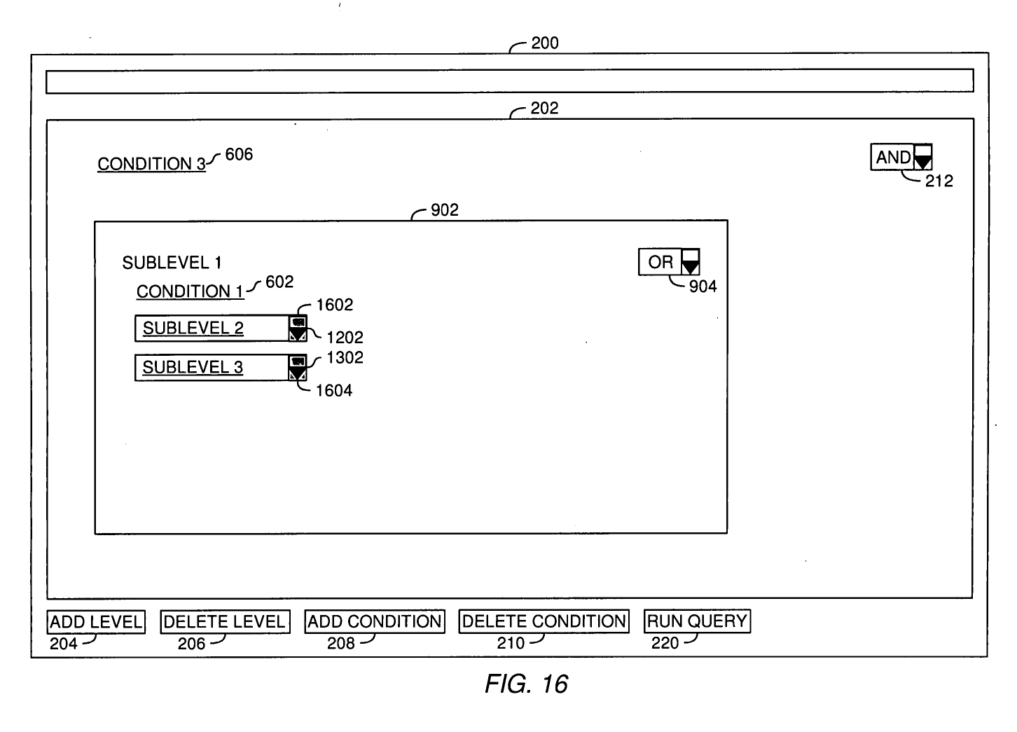

According to other embodiments of the invention, the levels and conditions used to form the queries may be displayed differently in the GUI 200. For example, in one embodiment, various regions representing different levels/nodes of a query may be windows or at least have functional characteristics of windows, such as minimization. FIG. 16 shows one embodiment in which each of the regions 1203, 1302 in the GUI 200 is minimized, thereby avoiding cluttering the screen. If the user decides to edit each of the levels represented by the regions 1202, 1302 which have been minimized, the user may maximize the regions using a graphical element 1602, 1604 provided next to each of the regions 1202, 1302.

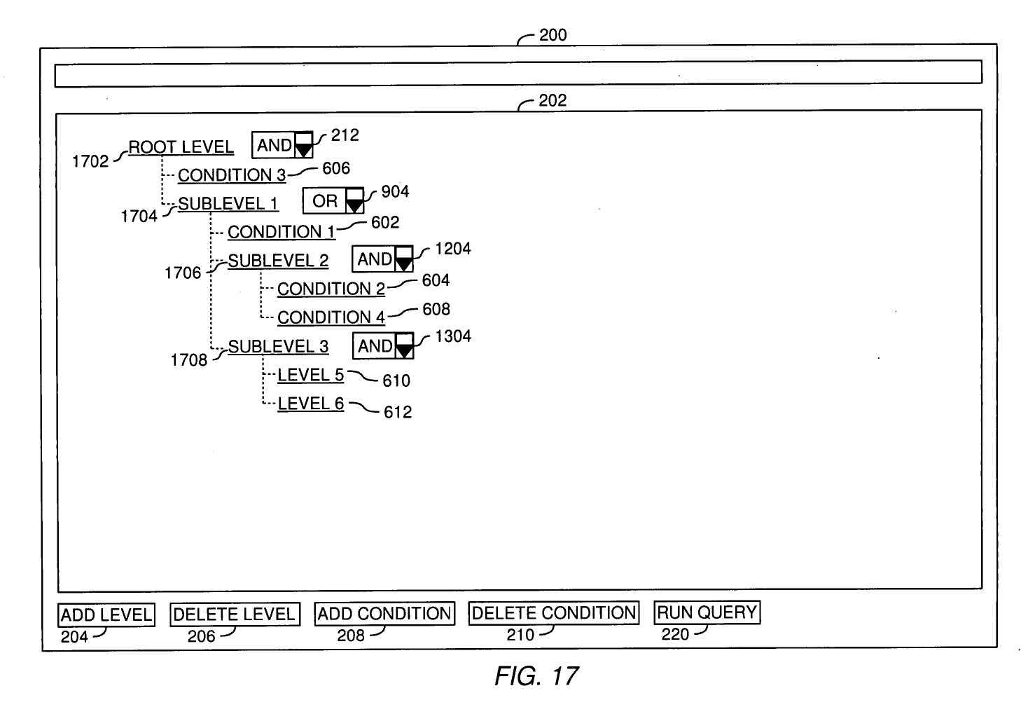

According to another embodiment of the invention, each of the levels and conditions which are used to form the query may be represented in a textual tree structure as depicted in FIG. 17. Each of the tree nodes may be indented away from the margin of the GUI 200 according to the level that the node occupies within the tree. A root level 1702 (with the least indentation) may be provided from which the rest of the tree stems. Next to each level name 1702, 1704, 1706, 1708, a graphical element 212, 904, 1204, 1304 may be provided which allows the user to select an operator to be applied to each of the items within that level. Thus, as depicted, the first level (labeled as the “Root Level” 1702) contains the third condition 606 (with one tab (i.e., indentation)) as well as a second level called “SUBLEVEL 1” 1704 (also with one tab). The second level contains the first condition 602 (with two tabs, etc.) as well as two levels, “SUBLEVEL 2” 1706 (which contains the second condition 604 and the fourth condition 608) and “SUBLEVEL 3” 1708 (which contains the fifth condition 610 and the sixth condition 612). The textual tree structure depicted in FIG. 17 represents the query (CONDITION 3 AND (CONDITION 1 OR (CONDITION 2 AND CONDITION 4) OR (CONDITION 5 AND CONDITION 6)) which is equivalent to the query depicted by the GUI 200 in FIG. 13. The user interface may provide the user with various functionalities to render the query hierarchy differently. For example, similar to the previous embodiment of FIG. 16, each node within the hierarchy may be collapsed to minimize the space it consumes within the user interface.

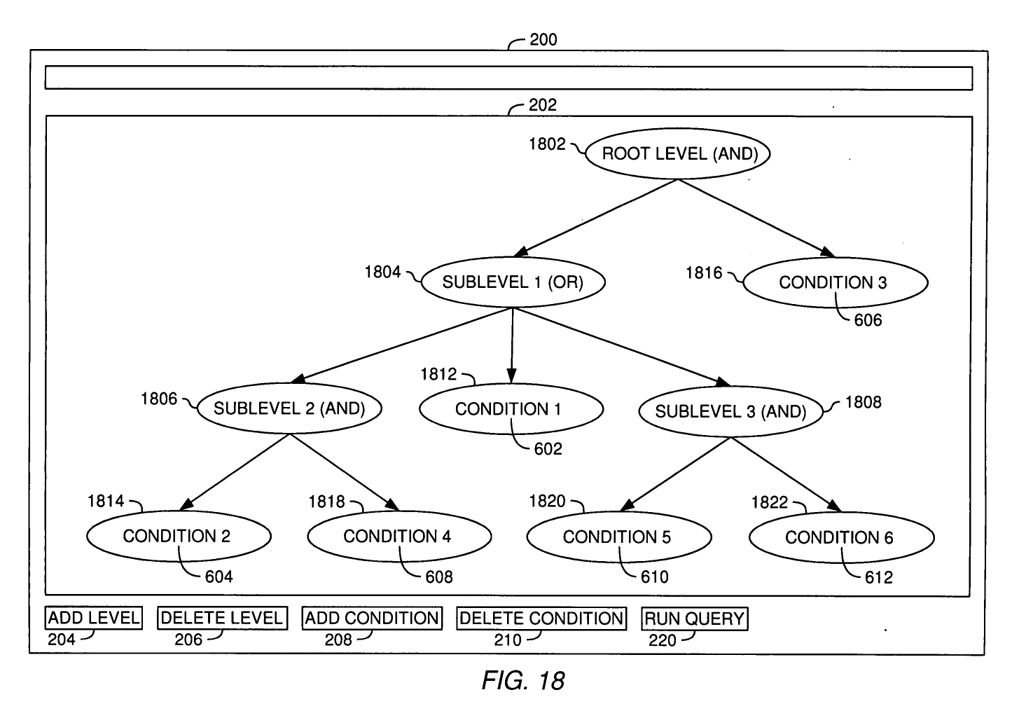

According to another embodiment of the invention, each of the levels and conditions which are used to form the query may be represented in a graphical tree structure as depicted in FIG. 18. Each of the tree nodes may be depicted as graphical nodes connected within the tree. A root level node 1802 may be provided from which the rest of the tree stems. Each level node 1802, 1804, 1806, 1808 may contain the name of the level as well as the selected operator which applies to that level. In one embodiment, the selected operator may be changed by clicking on the level node. The user may then be provided with a dialog box which allows the user to change the selected operator. In other embodiments, the user may be provided a graphical element such as a drop-down box which allows the user to select the operator.

Arrows in the graphical tree structure may be used to depict the hierarchy of query sublevels. Thus, the graphical tree structure depicted in FIG. 18 shows that the first level represented by node 1802 contains the third condition 606 (represented by node 1816) as well as a second level represented by node 1804. The second level contains two levels (represented by nodes 1806 and 1808) and the first condition 602 (represented by node 1812). The third level, represented by node 1806 and named “SUBLEVEL 2”, contains two conditions (represented by nodes 1814 and 1818) and the third level, represented by node 1806 and named “SUBLEVEL 3”, also contains two conditions (represented by nodes 1820 and 1822). The graphical tree structure depicted in FIG. 18 represents the query (CONDITION 3 AND (CONDITION 1 OR (CONDITION 2 AND CONDITION 4) OR (CONDITION 5 AND CONDITION 6)) which is equivalent to the query depicted by the GUI 200 in FIGS. 13 and 17.

While the foregoing is directed to embodiments of the present invention, other and further embodiments of the invention may be devised without departing from the basic scope thereof, and the scope thereof is determined by the claims that follow.

What is claimed is:

1. A method of programmatically providing a graphical user interface for creating queries, comprising:
displaying a first-level region of the graphical user interface containing two or more first-level query conditions and a first-level operator selection element for selecting a first-level logic operator from at least two logic operators, the selected first-level logic operator being applied to logically relate the two or more first-level query conditions to produce a first query portion; and
displaying at least one of the two or more first-level query conditions as a second level region containing two or more second-level query conditions and a second-level operator selection element for selecting a second-level operator from at least two logic operators, the selected second-level logic operator being applied to logically relate the two or more query second-level conditions within the second-level region to produce a second query portion;
wherein the first-level region and the second-level region are predefined to be logically related in a manner wherein the entire second query portion is logically related as an atomic unit to each of the other two or more query first-level query conditions of the first query portion according to the selected first-level operator.

2. The method of claim 1, wherein the second-level region is displayed within the first level region.

3. The method of claim 1, wherein the first and second level regions are windows and wherein the second-level region is displayed within the first level region.

4. The method of claim 1, further comprising:
creating the first-level region without the two or more first-level query conditions; and then
populating the first-level region with at least one of the two or more first-level query conditions; and then
creating the second-level region without the two or more second-level query conditions; and then
populating the second-level region with the two or more second-level query conditions.

5. The method of claim 1 wherein one or more graphical elements each representing the one or more query conditions are movable between the first-level region and the second-level region.

6. The method of claim 1, further comprising displaying N sublevel regions, the regions being displayed in a nested manner with respect to each other, the first level region and the second level region; and wherein at least some of the sublevel regions are configured for composing a separate complex query condition comprising two or more constituent query conditions and include a sublevel operator selection element for selecting a sublevel logic operator for logically relating the two or more constituent query conditions.

7. The method of claim 6, wherein each of the two or more constituent query conditions of a given sublevel region are individually logically related to a complex query condition of a next lowest sublevel region according to the selected sublevel logic operator of the given sublevel region.

8. The method of claim 6, wherein each of the regions is movable from one level to another level.

9. A method of programmatically providing a user interface for creating queries, comprising:
providing graphical user interface content which defines a graphical user interface, comprising:
a first-level region for displaying one or more first-level query conditions and containing a first-level operator selection element for allowing user selection of a first-level operator from at least two operators, the selected first-level operator being applied to logically relate the one or more first-level query conditions;
a second-level region for displaying two or more second-level query conditions and containing a second-level operator selection element for allowing user selection of a second-level operator from at least two operators, the selected second-level operator being applied to the two or more second-level query conditions within the second-level region to form a second-level complex condition; and
applying the selected first-level operator to the second-level complex condition and the one or more query conditions of the first-level region to form a first-level complex condition.

10. The method of claim 9, wherein one or more graphical elements each representing the one or more query conditions are movable between the first-level region and the second-level region.

11. The method of claim 9, further comprising displaying N sublevel regions, the regions being displayed in a nested manner with respect to each other, the first level region and the second level region; and wherein each sublevel region is configured for composing a separate complex query condition comprising two or more constituent query conditions and includes a sublevel operator selection element for selecting a sublevel logic operator for logically relating the two or more constituent query conditions.

12. The method of claim 11, wherein each of the two or more constituent query conditions of a given sublevel region are individually logically related to a complex query condition of a next lowest sublevel region according to the selected sublevel logic operator of the given sublevel region.

13. A method of programmatically providing a user interface for creating queries, comprising:
displaying a top level window for displaying query conditions, wherein the top level window includes a logic operator selection element for selecting a top level logic operator from at least two logic operators; and
creating N nested windows, each for composing a separate complex query condition comprising two or more constituent query conditions, wherein each nested window includes an associated logic operator selection element for selecting a logic operator to logically relate the two or more constituent query conditions of the respective nested window; and wherein, relative to a given nested window, the logic operator of the next highest window selected from the top level window and the N nested windows is applied to logically relate the individual query conditions of the next highest window to the respective complex condition of the given nested window.

14. The method of claim 13, wherein each of the N nested windows is movable between each of the other N nested windows and the top level window.

15. A computer-readable medium containing a program which, when executed, performs an operation, comprising:
programmatically providing a graphical user interface for creating queries, comprising:
displaying a first-level region of the graphical user interface containing one or more query conditions and a first-level operator selection element for selecting a first-level logic operator from at least two logic operators, the selected first-level logic operator being applied to logically relate the one or more query conditions to produce a first query portion; and
displaying a second level region containing two or more query conditions and a second-level operator selection element for selecting a second-level operator from at least two logic operators, the selected second-level logic operator being applied to logically relate the one or more query conditions within the second-level region to produce a second query portion;
wherein the first level region and the second level region are predefined to be logically related according to the selected first-level operator so that the one or more query conditions of the first query portion are individually logically related to the entire second query portion according to the selected first-level operator.

16. The computer-readable medium of claim 15, further comprising displaying N sublevel regions, the regions being displayed in a nested manner with respect to each other, the first level region and the second level region; and wherein each sublevel region is configured for composing a separate complex query condition comprising two or more constituent query conditions and includes a sublevel operator selection element for selecting a sublevel logic operator for logically relating the two or more constituent query conditions.

17. The computer-readable medium of claim 16, wherein each of the two or more constituent query conditions of a given sublevel region are individually logically related to a complex query condition of a next lowest sublevel region according to the selected sublevel logic operator of the given sublevel region.

18. An apparatus, comprising:
a memory containing at least an application; and
a processor communicably connected to the memory, and which, when executing the application, performs an operation of generating a user interface for creating queries, the operation comprising:
displaying a first-level region of the graphical user interface containing one or more query conditions and a first-level operator selection element for selecting a first-level logic operator from at least two logic operators, the selected first-level logic operator being applied to logically relate the one or more query conditions to produce a first query portion; and
displaying a second level region containing two or more query conditions and a second-level operator selection element for selecting a second-level operator from at least two logic operators, the selected second-level logic operator being applied to logically relate the one or more query conditions within the second-level region to produce a second query portion;
wherein the first level region and the second level region are predefined to be logically related according to the selected first-level operator so that the one or more query conditions of the first query portion are individually logically related to the entire second query portion according to the selected first-level operator.

19. The apparatus of claim 18, further comprising displaying N sublevel regions, the regions being displayed in a nested manner with respect to each other, the first level region and the second level region; and wherein each sublevel region is configured for composing a separate complex query condition comprising two or more constituent query conditions and includes a sublevel operator selection element for selecting a sublevel logic operator for logically relating the two or more constituent query conditions.

20. The apparatus of claim 19, wherein each of the two or more constituent query conditions of a given sublevel region are individually logically related to a complex query condition of a next lowest sublevel region according to the selected sublevel logic operator of the given sublevel region.
